(19) United States
(12) Patent Application Publication
(10) Pub. No.: US 2003/0159331 A1
(43) Pub. Date: Aug. 28, 2003

(54) Anchored slip sinker

(76) Inventor: B. Phil Pasley, Shreveport, LA (US)

Correspondence Address: John M. Harrison, 2139 E. Bert Kouns, Shreveport, LA, 71105, US

(21) Appl. No.: 10/189,758

(22) Filed: Jul. 8, 2002

Related U.S. Application Data
(63) Continuation-in-part of application No. 10/084,752, filed on Feb. 26, 2002, now abandoned.

(51) Int. Cl. A01K 91/00; A01K 93/00; A01K 95/00

(52) U.S. Cl. 43/44.9

(57) ABSTRACT

An anchored slip sinker characterized by a generally tapered or conical body portion fitted with an internal longitudinal line aperture for receiving a fishing line tied to the eye of a hook, upon which hook a plastic fishing lure is impaled. The base end of the slip sinker is provided with a keeper/retainer wire characterized by a keeper leg, typically embedded in the sinker body, and a keeper bend or bends extending the keeper leg, which keeper bend or bends terminates in variously configured retainer segments. The retainer segment ends of the keeper are designed to extend laterally through or into the flexible fishing lure and the eye of the hook embedded in the flexible plastic lure, to lock the slip sinker against the flexible plastic lure and prevent it from sliding on the fishing line and keep the flexible plastic lure from sliding on the hook. The retainer segments are shaped to prevent the keeper wire from exiting the hook eye when the lure is cast and retrieved.

### CROSS-REFERENCE TO RELATED APPLICATIONS

This application is a continuous-in-part of my co-pending U.S. application Ser. No. 10/084,752, filed Feb. 26, 2002.

### BACKGROUND OF THE INVENTION

1. Field of the Invention

This invention relates to fishing lures and more particularly, to soft plastic fishing lures and slip sinkers normally slidably mounted on fishing line attached to hooks extending through the body of the fishing lures, for causing the fishing lures and hook to sink in a water body prior to and during retrieval by means of a rod and reel. These slip sinkers are typically tapered or conical in shape and are designed to slide up and down the fishing line in the proximity of the hook and fishing lure as the lure sinks and is retrieved in the water body.

2. Description of the Prior Art

One of the most effective lures in taking game fish, including fresh water variety such as large mouth and small mouth bass, crappie and the like, as well as salt water varieties including red fish, speckled trout and similar fish, is the flexible plastic lure, which can be molded in substantially any desired shape, size, color and consistency. One of the most popular techniques for retrieving plastic fishing lures at a desired depth in a water body is to fit a conical, typically metal slip sinker on the fishing line such that the slip sinker can slide up and down the fishing line and terminate at the lure and hook to cause the fishing lure to sink to a desired depth before and during retrieval. Retrieval of plastic fishing lures rigged in this manner is typically effected by initially lifting and subsequently lowering the tip of the fishing rod and operating the reel to facilitate raising the slip sinker and then falling of the slip sinker, causing the plastic fishing lure to assume a swimming appearance. Accordingly, the action of the slip sinker allows the fishing lure to be fished directly on the bottom of the water body, where the lure is typically bounced off the bottom in a swimming or crawling simulation, or fished at an intermediate depth, depending upon the speed of retrieval. Sometimes the sliding slip sinker can become snagged on an underwater obstacle as it separates from the lure and hook along the fishing line and the lure can also slide away from the eye of the hook, causing retrieval aberrations. It is therefore a common practice to immobilize the plastic lure on the partially embedded hook using a toothpick segment or the like extended through the lure and the embedded eye of the hook, to prevent the lure from sliding down the hook due to casting forces and water pressure during lure retrieval. Other techniques for achieving this objective include securing a wire retainer to the fishing line and extending it to the hook and anchoring one or more wire retainers in the slip sinker to engage the plastic lure and retain the lure in its desired position on the hook. The slip sinker is typically maintained in non-sliding position on the fishing line against the lure by this expedient or by means of a toothpick segment inserted in the slip sinker opening, tightly against the fishing line.

It has been found in the course of this invention that one end of a keeper wire can be fixed to or anchored or embedded in the base of a slip sinker and extended in various configurations to define a retainer segment that may be extended laterally or transversely through the head or hook eye end of a soft flexible lure such as a plastic worm, and then through the fishing line-tethered eye of the hook, to prevent the lure from sliding down the hook and the slip sinker from sliding on the fishing line tied to the hook eye.

It is therefore an object of this invention to provide a new and improved anchored slip sinker having a keeper for attachment to a hook tied to a fishing line, which keeper may be extended through flexible plastic fishing lures of various design, in order to lock the slip sinker to the hook and the lure and prevent the slip sinker from sliding up and down the fishing line and the lure from sliding on the hook and interfering with proper lure action during retrieval.

Another object of the invention is to provide a new and improved anchored slip sinker characterized by a tapered or conical, typically metal weight or sinker having a longitudinal bore for receiving a fishing line and fitted with a keeper having a retainer end or segment, which retainer end or segment is shaped for lateral or transverse extension through a plastic fishing lure and through the eye of a hook embedded in the lure, to facilitate anchoring the slip sinker to the hook and the fishing lure and minimizing dislocation of the fishing lure on the hook and sliding of the sinker on the fishing line tied to the hook eye, during casting and retrieval of the fishing lure using a rod and reel.

Still another object of this invention is to provide a new and improved slip sinker and technique for removably securing the slip sinker to the eye of a hook partially embedded in a plastic fishing lure in order to secure the slip sinker to both the hook and the lure, which technique includes attaching a wire keeper having a retainer end to, or embedding or casting one end of a wire keeper in the large or base end of the slip sinker, which sinker is normally slidably mounted on a fishing line extending longitudinally through the slip sinker and tied to the eye of the hook. The extending retainer end of the typically curved wire keeper is projected laterally into the head end of the lure and through the eye of the hook, to secure the hook and the fishing lure to the slip sinker, thus enabling retrieval of the slip sinker and lure through a water body using a rod and reel, without movement of the slip sinker along the fishing line and with little or no undesirable slippage of the lure on the hook.

Yet another object of the invention is to provide a method for securing a slip sinker to a plastic fishing lure and a hook upon which the lure is impaled and the hook eye embedded, which method includes the steps of providing the slip sinker with a keeper having a retainer segment or end of selected configuration and extending the curved or shaped retainer end or segment into the impaled end of the lure and through the adjacent embedded eye of the hook after the slip sinker is threaded on a fishing line tied to the hook eye, to prevent the slip sinker from sliding on the fishing line and sliding of the lure on the hook, during casting and retrieval of the lure.

### SUMMARY OF THE INVENTION

These and other objects of the invention are provided in a new and improved anchored slip sinker characterized by a generally conical or tapered, typically metal slip sinker body having a longitudinal internal opening or bore for receiving a fishing line attached to the eye of a hook embedded in a plastic fishing lure. The slip sinker further includes a curved or bent wire keeper/retainer having a keeper end attached to, or cast or embedded in the slip sinker base offset from the bore and fitted with a keeper bend or bends of selected shaped and orientation and a retainer segment at the extending free end of the keeper, for lateral insertion through or into the lure and through the embedded hook eye to secure the slip sinker to the hook and against the plastic fishing lure when the lure is cast and retrieved.

A method of immobilizing a conical or tapered slip sinker on a fishing line and impeding slippage of a flexible plastic lure impaled on a hook secured to the fishing line, which method includes the steps of mounting a curved or bent keeper on or in the large end or base of the slip sinker, with a shaped keeper bend or bends provided in the extending keeper, to define a retainer end or segment; extending the retainer segment laterally into the plastic fishing lure and through the eye of the hook; and either embedding the retainer in the plastic fishing lure or projecting the retainer from the opposite side of the plastic fishing lure from the entry point, to secure the slip sinker to the hook and the fishing lure, and the fishing lure on the hook, during casting of the lure and retrieval of the lure through a water body using a rod and reel.

### BRIEF DESCRIPTION OF THE DRAWINGS

The invention will be better understood by reference to the accompanying drawings wherein:

FIG. 1 is a perspective view of a preferred embodiment of the anchored slip sinker of this invention attached to a hook extended through and partially embedded in a flexible plastic fishing lure, with a fishing line extending through the anchored slip sinker and tied to the embedded eye of the hook, for casting the fishing lure and retrieving the slip sinker, fishing lure and hook as a fixed entity through a water body;

FIG. 2 is a perspective view of the anchored slip sinker illustrated in FIG. 1 with the lure illustrated in phantom, more particularly illustrating extension of a curved wire keeper/retainer projecting from the slip sinker into the head end portion of the plastic fishing lure and extending through the eye of the hook, to secure and anchor the slip sinker to the fishing lure body and the eye of the hook;

FIG. 3 is a side view of the straight retainer-anchored slip sinker, hook and lure body illustrated in FIG. 2;

FIG. 4 is a perspective view of the anchored slip sinker illustrated in FIGS. 2 and 3, more particularly illustrating conventional sliding movement of the slip sinker on the fishing line when the straight retainer element, end or segment of the wire keeper extending from the slip sinker base is not extended through or into the lure and through the eye of the hook;

FIG. 5 is a perspective view of the anchored slip sinker illustrated in FIGS. 1-4, more particularly illustrating the straight retainer segment terminating the free end of the curved keeper bend;

FIG. 6 is a perspective view of the anchored slip sinker of this invention, more particularly illustrating a continuous retainer terminating the free end of the curved keeper bend;

FIG. 7 is a sectional view taken along line 7-7 of the slip sinker illustrated in FIG. 5;

FIG. 8 is a sectional view taken along line 8-8 of the slip sinker illustrated in FIG. 6;

FIG. 9 is a side view of an anchored slip sinker fitted with an offset half retainer segment terminating the keeper bend;

FIG. 10 is a side view of an anchored slip sinker fitted with a recurve retainer segment terminating the keeper bend;

FIG. 11 is a side view of an anchored slip sinker fitted with a straight half retainer segment terminating the keeper bend;

FIG. 12 is a side view of an anchored slip sinker fitted with a box retainer segment terminating the keeper bend; and

FIG. 13 is a side view of an anchored slip sinker fitted with a half box retainer segment terminating the keeper bend;

### DESCRIPTION OF THE PREFERRED EMBODIMENTS

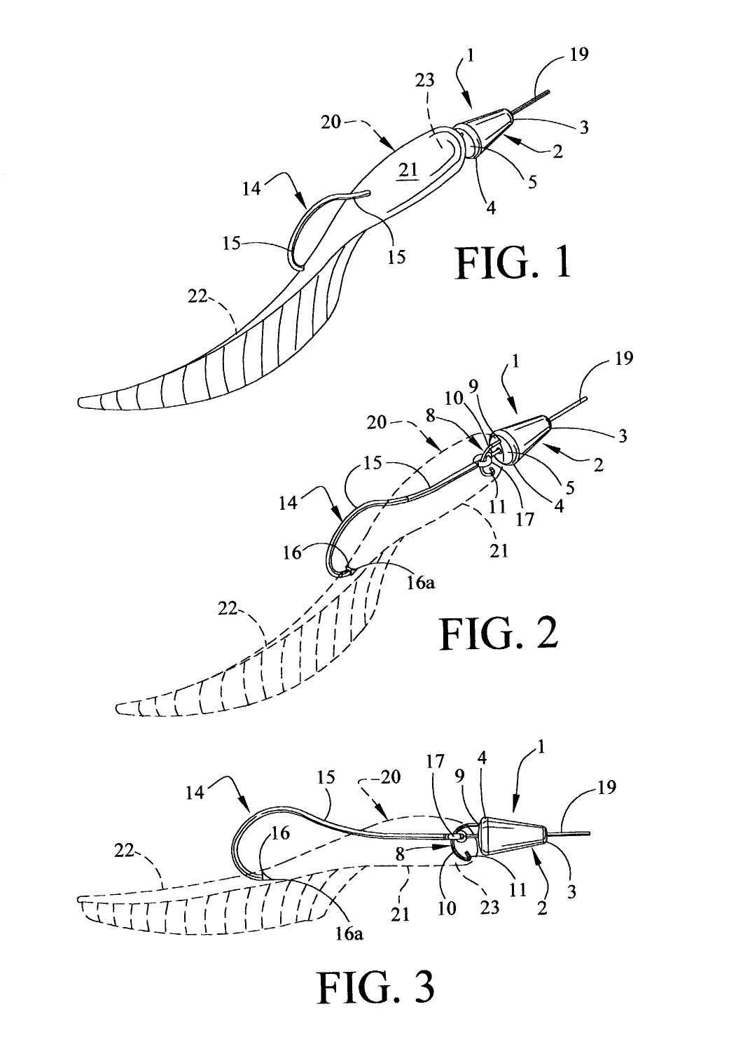

Referring initially to FIGS. 1-5 and 7 of the drawings, in a preferred embodiment the anchored slip sinker of this invention is generally illustrated by reference numeral 1. The anchored slip sinker 1 is characterized by a conical or tapered, typically metal sinker body 2, defining a rounded tip 3 at one end, tapering to a larger rounded base edge 4 and base 5 at the opposite end. A line aperture 6 extends longitudinally through the entire length of the sinker body 2 from the tip 3 to the base 5 to accommodate a segment of fishing line 19, as illustrated in FIGS. 5-7. A curved keeper wire 8 includes a keeper leg 9, typically embedded in the base 5 of the sinker body 2 at a point offset from the line aperture 6 and a keeper bend 10 is defined in the extending portion of the keeper leg 9 and terminates in a short straight retainer segment 11, as illustrated. It will be appreciated from a consideration of FIGS. 5 and 7 that in a preferred embodiment the keeper bend 10 curves through a line aperture plane 7 that extends in the line aperture 6 in the base 5, for purposes which will be hereinafter described.

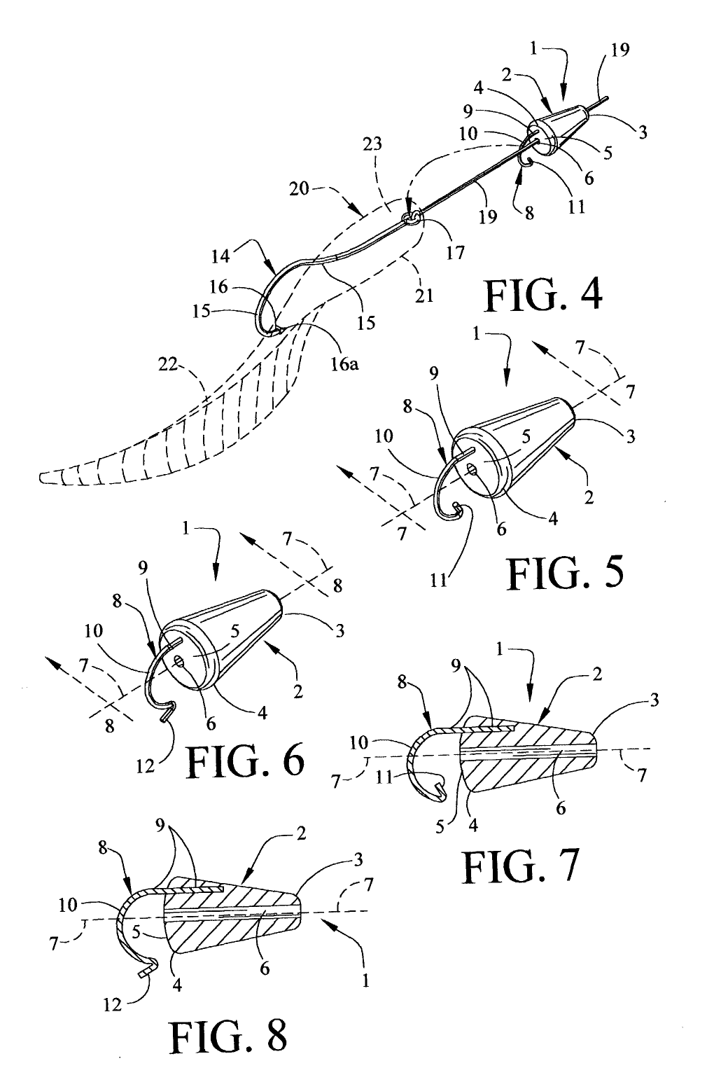

Referring now to FIGS. 1-4 of the drawings, a hook 14 is illustrated, having a shank 15 which extends linearly from an eye 17, to which the fishing line 19 is tied, and curves to define a barb 16 and a hook tip 16a. The curved portion or segment of the shank 15 of the hook 14 is threaded through the lure body 21 of a flexible plastic lure 20 (illustrated in phantom) and the eye 17 is embedded in the upper or head end 23, of the lure body 21. In a preferred embodiment the curved segment of the shank 15 is extended and manipulated through the soft plastic lure body 21 of the flexible plastic lure 20, such that the barb 16 and hook tip 16a of the hook 14 are embedded in the lure body 21 or the lure tail 22 to facilitate retrieval, and movement of the flexible plastic lure 20 through the water in a weedless fashion that enables uninhibited simulated “swimming” of the lure. As the hook 14 is embedded in the lure body 21 or lure tail 22 of the flexible plastic lure 20 as illustrated in the drawings, the eye 17 is extended into and embedded in the head end 23. The straight retainer segment 11 of the keeper 8 is then inserted laterally or transversely through the lure body head end 23 and through the eye 17 of the hook 14, to the keeper bend 10, as further illustrated in FIGS. 2 and 3. This configuration of the anchored slip sinker 1 causes the anchored slip sinker 1 to be secured to the head end 23 of the lure body 21 and also to the hook 14, as illustrated in FIGS. 1 and 2. The lure and slip sinker stabilizing configuration thus prevents, or at least minimizes, the tendency of the lure body 21 to slide on the shank 15 of the hook 14, away from the eye 17 during casting and retrieval of the lure, to a position that interferes with a proper life-like simulated “swimming” action of the lure and causes the flexible plastic lure 20 and the fishing line 19 to twist. Moreover, since the fishing line 19 has been previously threaded through the line aperture 6 in the sinker body 2 of the anchored slip sinker 1 and tied prior to embedment of the now embedded eye 17 of the hook 14, the anchored slip sinker 1 cannot slip up and down the fishing line 19 as it normally would under circumstances where the straight retainer segment 11 and the keeper bend 10 of the keeper 8 are not inserted through the eye 17, as illustrated in FIG. 4. This locking of the anchored slip sinker 1 to the flexible plastic lure 20 and the hook 14 thus insures that the anchored slip sinker 1 will move in concert with the flexible plastic lure 20 and the hook 14 during casting and retrieval of the flexible plastic lure 20 through a water body by operation of a rod and reel (not illustrated), to minimize the characteristically frequent snagging of the slip sinker body 2 on underwater obstacles when it is spaced from the flexible plastic lure 20, as further illustrated in FIG. 4.

Referring to FIGS. 6 and 8 of the drawings, in another preferred embodiment of the invention the keeper bend 10 in the curved free end of the keeper leg 9 is terminated by a short, outwardly-bent, continuous retainer segment 12, which serves the same purpose as the short, inwardly-bent straight retainer segment 11, illustrated in FIGS. 4, 5 and 7 in securing the keeper bend 10 of the keeper 8 in the eye 17 of the hook 14. As in the case of the short straight retainer segment 11 illustrated in FIGS. 4, 5 and 7, the short continuous retainer segment 12 and the keeper bend 10 are most preferably extended directly over and in alignment with the line aperture plane 7 of the line aperture 6, to facilitate alignment of the keeper bend 10 of the keeper 8 with the eye 17 of the hook 14 and to locate the eye 17 in alignment with the longitudinal centerline of the sinker body 2 when the anchored slip sinker 1 is rigged as illustrated in the drawings.

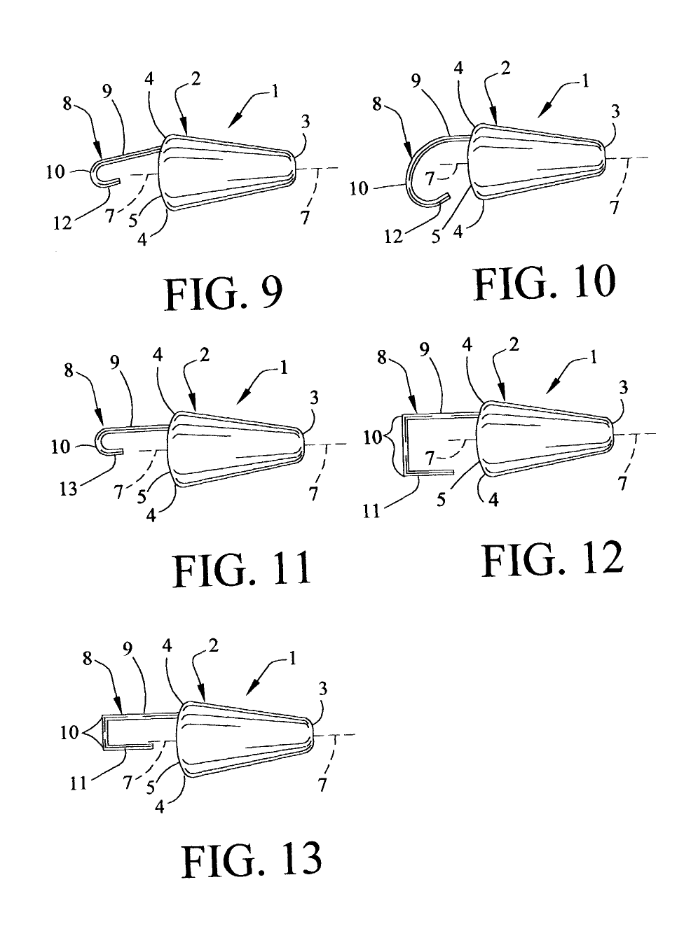

Referring now to FIG. 9 of the drawings in another embodiment of the invention the keeper leg 9 of the keeper 8 extends downwardly from the base 5 of the sinker body 2, offset from the line aperture 6, as described above, and toward the line aperture plane 7 of the line aperture 6 and, with the keeper bend 10, and defines an offset half retainer segment configuration, with a continuous retainer segment 12 terminating the keeper bend 10. In a preferred embodiment of the invention the extending end of the continuous retainer segment 12 is at or near the line aperture plane 7 of the line aperture 6 for extending laterally through the head end 23 of a flexible plastic lure 20 and securing the anchored slip sinker 1 in place on the flexible plastic lure 20, as illustrated in FIG. 1 and described above.

In another embodiment of the invention the keeper leg 9 of the keeper 8 is curved to define a continuous retainer segment 12 that recurves back toward the rounded base 5 of the anchored slip sinker 1, as illustrated in FIG. 10. Accordingly, the recurve end of the continuous retainer segment 12 is extended laterally and transversely to the longitudinal plane of the flexible plastic lure 20, through the head end 23 of the flexible plastic lure 20 and through the eye 17 of the hook 14 as in FIGS. 2 and 3, to secure the anchored slip sinker 1 on the flexible plastic lure 20 and the hook 14, as illustrated in FIG. 1 and described above.

In yet another embodiment of the invention the keeper leg 9 of the keeper wire 8 extends from the base 5 of the anchored slip sinker 1 as illustrated in FIG. 11 and defines an offset half retainer segment 13, extending from the keeper bend 10. The offset half retainer segment 13 terminates at or near the line aperture plane 7 of the line aperture 6 illustrated in FIGS. 7 and 8. As in the case of the embodiments heretofore described and illustrated in the drawings, the extending end of the offset half retainer segment 13 is projected laterally through the head end 23 of the flexible plastic lure 20 and through the eye 17 of the hook 14 to secure the anchored slip sinker 1 on the flexible plastic lure 20 and the hook 14, as illustrated in FIG. 1 and as described above.

Referring now to FIG. 12 of the drawings, in another embodiment of the invention, the keeper leg 9 of the keeper 8 extends outwardly from the rounded base 5 of the anchored slip sinker 1 and a pair of substantially 90-degree keeper bends 10 are provided in the keeper 8 to define a straight retainer segment 11 that projects toward the rounded base 5 and terminates for lateral insertion in the head end 23 of the lure body 21 and through the eye 17 of the hook 14, to secure the anchored slip sinker 1 on the flexible plastic lure 20 and on the hook 14, as illustrated in FIG. 1.

In another embodiment of the invention the keeper leg 9 extends outwardly from the base 5 of the anchored slip sinker 1 and the keeper 8 is shortened to define a pair of keeper bends 10 and a straight retainer segment 11 projecting toward the base 5 of the anchored slip sinker 1, approximately at or in the line aperture plane 7 extending through the line aperture 6 illustrated in FIGS. 7 and 8. As in the case of the embodiment illustrated in FIG. 12, the projecting end of the straight retainer segment 11 may be extended laterally through the head end 23 of the fishing lure body 21 and through the eye 17 of the hook 14 to secure the anchored slip sinker 1 on the flexible plastic lure 20, as illustrated in FIG. 1.

It will be appreciated by those skilled in the art that the anchored slip sinker of this invention, in all of the embodiments described above, facilitates an efficient, secure and easily implemented device and technique for securing a slip sinker to the eye of a hook tied directly to a fishing lure and embedded in the body of a plastic fishing lure and to the lure itself, thus preventing the anchored slip sinker from sliding up and down the fishing line during casting and retrieving of the lure. Referring again to FIG. 1 of the drawings, in the illustrated stabilized configuration, the anchored slip sinker 1 serves to further render the flexible plastic lure 20 weedless, in that the slip sinker is tapered from the rounded tip 3 to the rounded base 5, thus facilitating easy bouncing over rocks, limbs, submerged logs and the like, with minimum snagging or hanging of the lure, thus allowing more snag-free retrievals. In addition, extension of the keeper bend or bends and the variously configured retainer segments or ends of the keeper 8, laterally through or into the head end 23 of the lure body 21 adjacent to the eye 17 of the hook 14, helps to stabilize the lure body 21 on the hook 14 and minimize slippage of the lure body 21 on the hook 14, away from the eye 17.

Furthermore, the slip sinker 1 can be constructed of lead, steel, brass, ceramic or the like for sinking, or a plastic material for floating or non-floating fishing, as desired. This option facilitates proper positioning of the fishing lure 19 on the slip sinker 1 in both floating and sinking configurations when used, for example, in connection with a Carolina Rig.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A slip sinker for fitting on a fishing line tied to the eye of a hook embedded in a flexible fishing lure, said slip sinker comprising a slip sinker body, a longitudinal bore provided in said body for receiving the fishing line and a keeper having a shaped retainer segment extending from said slip sinker body for extending laterally through the flexible fishing lure and through the eye of the hook and securing said slip sinker to the flexible fishing lure and the eye of the hook.

2. The slip sinker of claim 1 wherein said shaped retainer segment comprises a straight retainer segment for preventing said keeper from exiting the eye of the hook.

3. The slip sinker of claim 2 wherein said keeper extends at an acute angle from said slip sinker body.

4. The slip sinker of claim 2 wherein said keeper extends at about a 90-degree angle from said slip sinker body.

5. A slip sinker comprising a tapered sinker body; an internal bore provided in said sinker body for receiving a fishing line tied to a hook having an eye embedded in a plastic fishing lure; and a wire keeper having one end carried by said sinker body and the other end of said wire keeper extending in a curve from said one end to define a retainer segment for projection laterally into the plastic fishing lure and through the eye of the hook for securing said slip sinker against the plastic fishing lure during casting and retrieval of the plastic fishing lure.

6. The slip sinker of claim 5 comprising at least one bend provided in said retainer segment for preventing said retainer segment from exiting the eye of the hook.

7. The slip sinker of claim 6 wherein said at least one bend is characterized by an inside retainer segment bend.

8. The slip sinker of claim 6 wherein said at least one bend is characterized by an outside retainer segment bend.

9. An anchored slip sinker for attachment to the eye of a hook embedded in a flexible plastic fishing lure, said anchored slip sinker comprising a tapered sinker body; an internal bore provided in said body for receiving a fishing line tied to the eye of the hook embedded in a plastic fishing lure; a wire keeper having one end embedded in said sinker body and the other end of said keeper extending in a curve from said one end; and a retainer segment extending said curve in said keeper, said retainer segment projecting laterally into the plastic fishing lure and through the eye of the hook for securing said retainer segment and said keeper in said eye of the hook and said slip sinker against the plastic fishing lure during casting and retrieval of the plastic fishing lure.

10. An anchored slip sinker for attachment to the eye of a hook embedded in a flexible plastic fishing lure, said anchored slip sinker comprising a tapered sinker body of selected size and weight; an internal bore provided in said body for receiving a fishing line tied to the eye of the hook; a wire keeper having one end embedded in said sinker body at a point spaced apart from said internal bore and the other end of said retainer extending from said one end; at least one bend provided in said keeper; and a retainer segment extending from said at least one bend, said retainer segment projecting laterally into the plastic fishing lure and through the eye of the hook for securing said retainer segment in said eye of the hook and said slip sinker against the plastic fishing lure during casting and retrieval of the plastic fishing lure.

11. The anchored slip sinker of claim 10 wherein said at least one bend comprises a pair of substantially 90-degree bends.

12. A method for securing a slip sinker to the eye of a hook secured to a fishing line and embedded in a plastic fishing lure, comprising the steps of providing a keeper having one end fixed to said slip sinker and the other end of said keeper extending from said one end to define a retainer segment, and extending said retainer segment laterally into the plastic fishing lure and through the eye of the hook for securing said slip sinker to the eye of the hook and against the plastic fishing lure during casting and retrieval of the plastic fishing lure.

13. The method of claim 12 comprising the step of providing at least one retainer bend in said retainer segment for inhibiting exiting of said retainer segment from the eye of the hook.

14. The method of claim 12 comprising the step of shaping a pair of retainer bends in said retainer segment for inhibiting exiting of said retainer segment from the eye of the hook.

15. The method of claim 12 comprising the step of shaping a continuous curve in said keeper and said retainer segment for inhibiting exiting of said retainer segment from the eye of the hook.

16. The method of claim 12 comprising the step of shaping a continuous curve in said keeper and a reverse curve in said retainer segment for inhibiting exiting of said retainer segment from the eye of the hook.
